(19) United States
(12) Patent Application Publication
(10) Pub. No.: US 2004/0112838 A1
(43) Pub. Date: Jun. 17, 2004

(54) System and method for optimized control of multiple oxidizers

(75) Inventor: Roy Martin, Downers Grove, IL (US)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: United States Filter Corporation, Palm Desert, CA

(21) Appl. No.: 10/669,102

(22) Filed: Sep. 23, 2003

Related U.S. Application Data
(63) Continuation-in-part of application No. 10/098,817, filed on Mar. 15, 2002, now Pat. No. 6,623,647.
Application No. 10/098,817 is a division of application No. 09/780,198, filed on Feb. 9, 2001, now Pat. No. 6,620,315.

(51) Int. Cl. C02F 1/72

(52) U.S. Cl. 210/739; 210/758; 210/96.1; 210/759

(57) ABSTRACT

A system and method for treating water in an aqueous system includes measuring or characterizing one or more specific oxidizing species by utilizing species-specific or selective techniques. The selective techniques utilize an amperometric or potentiometric sensor having a selective membrane or analytical techniques to provide an indication of a concentration of one or more oxidizing species. The system and method also determines an overall characteristic of the water, which can be used to control addition of additional oxidizing species.

### CROSS-REFERENCE TO RELATED APPLICATIONS

This application is a continuation-in-part application, and claims the benefit under 35 U.S.C. § 120, of pending U.S. patent application Ser. No. 10/098,817, filed on Mar. 15, 2002, which is a divisional application of U.S. patent application Ser. No. 09/780,198, filed on Feb. 9, 2001, which is now issued as U.S. Pat. No. 6,620,315, each of which are incorporated herein in their entireties.

### BACKGROUND OF THE INVENTION

(1) Field of the Invention

This invention relates to treating water systems and, in particular, to controlling the concentrations of oxidizers in water system by utilizing sensor that provide an indication of the concentration of at least one oxidizer in a multiple oxidizer environment.

(2) Description of Related Art

In the field of water and wastewater treatment, there has been an effort to combine oxidizers to achieve a synergistic effect, thereby exceeding the performance of the individual oxidizers.

Hale, in U.S. Pat. No. 5,030,334, teaches an ozone measuring method by utilizing an amperometric cell.

Muller et al., in U.S. Pat. No. 5,239,257, teach an amperometric probe with an ion selective membrane. Muller et al. fail to teach or disclose a measuring system for controlling oxidizers in a water treatment process by combining multiple sensors inclusive of at least one ion selective membrane enclosed amperometric sensor.

Brown et al., in U.S. Pat. No. 5,882,334, teach methods for treating regulated waters with low levels of oxidizing halogens and hydrogen peroxides.

Steininger et al., in U.S. Pat. No. 5,895,565, teach an integrated water treatment control system with probe failure detection.

Godec et al., in U.S. Pat. No. 5,902,751, teach measuring dissolved carbon with an ion selective membrane dividing deionized water from the oxidized sample water and a pair of micro-conductivity and temperature sensors.

Peachey-Stoner, in U.S. Pat. No. 6,030,842, teaches a method for determining free halogens in aqueous fluids utilizing an azine indicator material and a benzidine type catalyst material impregnated into a matrix carrier.

Itzhak, in U.S. Pat. No. 6,284,144, teaches a method of controlling biofouling in a water system by adding a redox buffer and oxidizing thereafter.

Silveri et al., in International Publication No. WO 99/24369 teach an amperometric halogen control system.

Grant et al., in U.K. Patent Application Publication No. GB 2 335 044, teach an apparatus for monitoring substances in an aqueous system.

These fail to optimize the control and/or optimize the feed or production of each oxidizer.

### BRIEF SUMMARY OF THE INVENTION

The present invention provides a system and method for treating aqueous systems comprising regulating addition of multiple oxidizers.

In accordance with one or more embodiments, the present invention provides a system for treating water in an aqueous system. The system can comprise a species-specific sensor disposed to measure a halogen species concentration of water in the aqueous system, an oxidation-reduction potential sensor disposed to measure an oxidation-reduction potential of the water, and a controller in communication with the species-specific sensor and the oxidation-reduction potential sensor and with a halogen donor source and a peroxygen source, the controller comprising an algorithm that regulates addition of a halogen donor species based on the halogen species concentration and addition of a peroxygen compound based on the oxidation-reduction potential.

In accordance with one or more embodiments, the present invention provides a system for treating water in an aqueous system comprising a controller in communication with a species-specific sensor disposed to measure a first oxidizer concentration of a first oxidizer in the aqueous system, a second sensor disposed to measure an overall oxidation reduction potential of the aqueous system, a first oxidizer source disposed to introduce the first oxidizer into the aqueous system, and a second oxidizer source disposed to introduce the second oxidizer into the aqueous system, the controller comprising an algorithm that analyzes the first oxidizer concentration and the second oxidizer concentrations and regulates addition of the first oxidizer based on the first oxidizer concentration and addition of the second oxidizer based on the second oxidizer concentration.

In accordance with one or more embodiments, the present invention provides a method of treating water in an aqueous system. The method can comprise steps of measuring a first oxidizer concentration of a specific oxidizer in water in the aqueous system, determining a first oxidizer demand according a difference between the measured first oxidizer concentration and a target first oxidizer concentration, controlling addition of the specific oxidizer to the aqueous system based on the first oxidizer demand, and controlling addition of a second oxidizer to the aqueous system based on an oxidation reduction potential of water in the aqueous system.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

FIG. 1 is a block diagram showing a water treatment system in accordance with one or more embodiments of the present invention;

FIG. 2 is a graph showing the relative concentration of chlorine and chlorine species as a function of pH;

FIG. 3 is a graph showing amperometric value as hydrogen peroxide is incrementally added to the solution.

### DETAILED DESCRIPTION OF THE INVENTION

Water and wastewater treatment systems typically utilize oxidizers to decontaminate or destroy undesirable species including organic and some inorganic compounds. For example, Advanced Oxidation Technologies (AOT) can employ ozone with peroxide to produce hydroxyl free radicals (hydroxyl radicals). Other oxidizers can be utilized; for example, hydrogen peroxide can be converted to hydroxyl free radicals using ultra violet radiation.

In a typical aqueous system, the demand, e.g. the difference from a target sanitized condition, for one or more oxidizers can change as a result of external, or even internal, perturbations. In pools for example, as bathers enter the pool water, organic contaminants are typically introduced that can introduce a demand. In order to maintain the same oxidation potential, a typical oxidation-reduction potential-based (ORP-based) control system would respond by increasing the concentration of an oxidizer, e.g. chlorine, in the water. The techniques of the present invention can ensure enough oxidizer has been added to satisfy the organic demand and to ensure sufficient residual oxidizer is available. For effective sanitization, chlorine should be maintained in sufficient concentrations to effectively provide for a safe environment. However, if another oxidizer is added to, for example, enhance oxidation of organic contaminants, the ORP-based control system can be compromised since either chlorine or the second oxidizer can satisfy the ORP requirement. That is, the presence of another oxidizer can misrepresent the condition of the aqueous system because the second or other oxidizer can contribute to the measured ORP without providing sufficient or effective sanitization. Should chlorine feed be compromised, the second oxidizer could be fed in sufficient concentrations to meet the ORP set-point. In such instance, sanitation of the water could be compromised. Further, because chlorine concentrations would likely be reduced, the synergistic effects provided by the combined effect of the two oxidizers would also be compromised.

The treatment systems in accordance with the present invention can utilize a halogen-based oxidizer, such as chlorine, in combination with a peroxygen-based oxidizer, such as potassium monopersulfate, to effectively eliminate or at least reduce the formation of volatile halogenated nitrogen based compounds. The halogen-based oxidizer and the peroxygen-based oxidizer, e.g. chlorine and potassium monopersulfate, can be fed to the water based on ORP based control. The present invention can utilize multiple oxidizers and incorporate dynamic optimization of the oxidizer ratios and verify individual oxidizer feed.

The present invention can provide water and wastewater treatment systems that can incorporate multiple oxidizers to provide a treatment synergistic effect. In accordance with one or more embodiments, the present invention can provide a system and method that utilizes multiple sensor systems to provide an indication of the condition of water or wastewater. In other embodiments, the present invention provides a system and method of controlling a water or wastewater treatment system by incorporating a plurality of devices that provide a characterization of each oxidizer in a multiple oxidizer environment. In still other embodiments, the present invention provides a treatment system and method that can determine a concentration of one or more oxidizer species, e.g. species-specific, and control or regulate addition of one or more oxidizer species based on the particular concentration of the specific oxidizer. In further embodiments, the present invention provides a treatment system that incorporates a plurality of sensors, each sensor disposed and constructed to measure a concentration of an oxidizer in a multiple oxidizer environment. In still further embodiments, the present invention provides a treatment system comprising a first sensor that can measure a first oxidizer concentration and a second sensor that can measure a second oxidizer concentration as well as a controller that receives a signal corresponding to the respective measured concentrations and regulates addition of the first oxidizer and the second oxidizer accordingly.

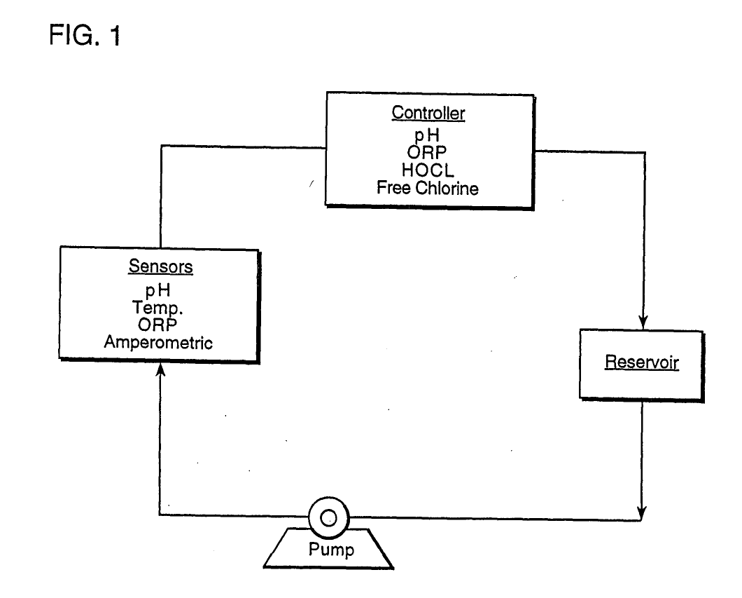

FIG. 1 is a block diagram showing a treatment system for an aqueous system in accordance with one or more embodiments of the present invention. The aqueous system, represented as the reservoir, is typically fluidly connected to the treatment system comprising sensors and a controller. A pump can circulate water through each of these subsystems. The sensors can comprise at least one of a pH, temperature, ORP, amperometric, potentiometric, and analytical sensors in fluid communication with the aqueous system. The controller is typically in communication with the aqueous system and can comprise subsystems for delivering oxidizing species, exemplarily shown as HOCl and free chlorine but can include peroxygen sources as well as other suitable oxidizing species. The controller can further comprise auxiliary subsystems (not shown) for receiving measured characteristics, e.g. concentration, pH, temperature, of the water in the aqueous system as well as one or more microprocessors (not shown) that analyze the measured data to regulate addition of one or more oxidizers according to, for example, a determines oxidizer demand. The controller typically comprises hardware and software to facilitate such control. Thus, in the embodiment shown in FIG. 1, the aqueous system can be treated by measuring one or more characteristics of the water of the aqueous system and regulating addition of each oxidizer in a multiple oxidizer treatment system.

Thus, in accordance with one or more embodiments, the present invention provides a treatment system. The treatment system can comprise a controller in communication with a species-specific sensor disposed to measure a first oxidizer concentration of a first oxidizer in the aqueous system, a second sensor disposed to measure an overall oxidation-reduction potential of the aqueous system, a first oxidizer source disposed to introduce the first oxidizer into the aqueous system, and a second oxidizer source disposed to introduce the second oxidizer into the aqueous system. The controller typically comprises an algorithm that analyzes the first oxidizer concentration and the second oxidizer concentrations and regulates addition of the first oxidizer based on the first oxidizer concentration and addition of the second oxidizer based on the second oxidizer concentration.

The present invention can utilize one or more sensors that can determine an overall condition of an aqueous system as well as a characteristic, preferably a species-specific characteristic, of one or more species in the aqueous system. The overall condition can be determined by determining an aggregate oxidation capacity of oxidizing species in the water. The characteristic of said one or more species can be determined by utilizing one or more sensors or systems that provide a measure of, for example, the concentration of a particular species when such species is present in a multiple oxidizer environment.

The present invention can further provide optimized control of multiple oxidizers in aqueous systems. The present invention can also provide optimized control of multiple oxidizers in aqueous systems by regulating addition of one or more oxidizers in response to a demand that is created when the concentration of one or more oxidizers deviates from a target level.

A nonspecific measure of the overall condition of the aqueous system can be provided by determining, for example, its relative oxidation-reduction equilibrium or redox potential. Thus, in accordance with one or more embodiments, the present invention comprises measuring or determining an oxidation-reduction potential, typically performed with an ORP sensor, of the aqueous system. In some embodiments, the nonspecific technique can provide an ORP potential of the aqueous system when multiple oxidizers, e.g. two or more oxidizers, are present.

A specific characteristic, e.g. activity, can be determined by, for example, measuring any change in voltage associated with a particular species. A measured change in current associated with a particular species, for a fixed potential, can also provide a determination of the specific characteristic. In some cases, the determination of specific characteristics can further utilize selective techniques to provide a measure of the activity of the particular species. Thus, in accordance with one or more embodiments, the present invention comprises utilizing amperometric, or potentiometric, sensor technology, e.g. at least one amperometric sensor that employs ion selective or permeable membrane to provide an indication of the activity of a particular, specific species. The ion selective membrane can be utilized with potentiometric and/or amperometric techniques that can provide an indication of a species-specific characteristic of the aqueous system.

In accordance with one or more embodiments, the present invention can utilize a sensor that can provide rapid and reliable analysis. Examples of such sensors include solid-state sensors that can measure a characteristic of a particular oxidizing species, such as free chlorine. Solid-state sensors can provide rapid and reliable analysis because they are typically smaller and can be electronically evaluated during operation. Solid-state sensor can be made by deposition a polymeric membrane on a conductive substrate. Thus, they can provide rapid and reliable data because, it is believed, they do not incorporate an electrolyte solution. The sensors, including solid-state sensors, can further utilize one or more selective membranes. The selective membrane serves to prohibit undesirable species, i.e. species not being measured, from being detected or characterized. The solid-state sensor of the present invention can comprise an electronic conductor, such as a bromide sensor film of AgBr, in contact with Ag, or cation salts in contact with Pt. Suitable solid-state sensors include those disclosed by, for example, Yoon et al. in “Solid-state ion sensors with a liquid junction-free polymer membrane-based reference electrode for blood analysis,” Sensors and Actuators B64, pp. 8-14 (2000), which is incorporated herein by reference in its entirety.

Commercially available sensors that can be used in accordance with the present invention include those from Sensicore, Inc., Ann Arbor, Mich. and Sartorious AG, Goettingen, Germany. Suitable selective membranes include, for example, polyurethane-based membranes, homogeneous or heterogeneous membranes such as crystalline Ag₂S or AgI/Ag₂S, silicone rubber or PVC on hydrophobized graphite or conducting epoxy resin. The sensors of the present invention can comprise non-crystalline electrodes which typically include a support matrix with an ion exchanger (cationic or anionic or a combination thereof), a solvent, and, in some cases, an uncharged selectivity-enhancing species. The matrix can be macroporous, typically comprising a polymeric material such as poly(propylene carbonate) filter or an inorganic material such as glass frit. In other cases the matrix can be microporous, typically comprising a polymeric material such as PVC. Other membranes that may be suitable include, for example, those comprising polystyrenesulfonate, sulfonated poly(tetrafluoroethylene), poly(vinyl chloride), and poly(propylene carbonate) as well as membranes incorporating charged species such as, but not limited to, tetra-p-chlorophenylborate, dinonylnaphthalene sulfonate.

Further, in accordance with one or more embodiments, the present invention can comprise utilizing a combination of sensor technologies to separately or independently control the concentration of individual oxidizers in a multiple oxidizer system by, for example, verifying the concentration or presence of each oxidizer and optimize an effect of each oxidizers. For example, in a treatment system utilizing a halogen-based oxidizer and a peroxygen-based oxidizer, the treatment system can comprise at least one amperometric sensor incorporating an ion selective membrane in conjunction with one or more of ORP, pH, and temperature sensor technologies. In other embodiments, the treatment system can utilize a halogen-based oxidizer and a peroxygen-based oxidizer, the treatment system can comprise at least one potentiometric sensor incorporating an ion selective membrane in conjunction with one or more of ORP, pH, and temperature sensor technologies. These sensors provide data to a controller, typically a microprocessor or analog based computer. The controller can incorporate a variety of modes of control techniques such as, but not limited to, time-based-proportional, proportional, proportional-integral, proportional-integral-differential and/or on/off control techniques to control or regulate addition of multiple oxidizers into an aqueous system. To further improve control, the controller can utilize algorithms that incorporate fuzzy logic or Boolean logic protocols to provide the ability to make changes to various settings or feed adjustments based on an evaluation of data.

In accordance with one or more embodiments, the present invention can utilize analytical techniques to detect and/or quantify a relative and/or absolute concentration or composition of target species, i.e. a specific species, in the aqueous system. For example, analytical techniques can be utilized to quantify one or more organic species present in the water of the aqueous system or the concentration of one or more oxidizing species in the aqueous system. Analytical techniques can also be utilized in the techniques of the present invention to provide an indirect indication of the effective concentration of an oxidizing species by, for example, detecting and/or analyzing a byproduct of a decomposition reaction of an organic contaminant by a free halogen species.

In some embodiments, the analytical techniques can be used in conjunction with any one of the various electrochemical analysis techniques. Thus, in accordance with one or more embodiments, the present invention can determine an overall condition, such as ORP, of the water as well as analytically characterize any organic species composition; if the measured ORP exceeds a target level, then one or more oxidizers, either simultaneously or in sequence can be introduced into the aqueous system. If the measured ORP is within acceptable limits relative to a target ORP but a specific or overall organic level is exceeded, as analyzed, then a specific oxidizer can be introduced. In other embodiments, an overall condition of the aqueous system can be characterized by utilizing analytical techniques to provide, for example, an aggregate level of organic composition or an aggregate level of oxidizer condition. Thus, in accordance with one or more embodiments, the control system in accordance with the present invention can utilize a species-specific measurement, as determined, by an analyzer to control addition an oxidizer and also utilize an overall measurement of the oxidizer level, as characterized by the analyzer, to control addition of another oxidizer.

Examples of suitable analytical techniques that can be used include, but are not limited to, calorimetric, chromatographic, or wet-chemistry techniques such as the N,N Diethyl p-phenylene diamine (DPD) ferrous titrimetric method as well as those using a DIONEX® 500 ion chromatograph, available from the Dionex Corporation, Sunnyvale, Calif. An example of a calorimetric system includes the HACH® CL17 Chlorine Analyzer system, available from Hach Company, Loveland, Colo.

In further embodiments of the invention, AOT applications employ at least one amperometric or potentiometric sensor utilizing an ion selective membrane with one or more amperometric sensors without an ion selective membrane. These sensors can be in communication with a microprocessor or analog based computer or controller to provide a characterization of the condition of the aqueous system.

The function and advantage of these and other embodiments of the present invention will be more fully understood from the examples below. The following examples are intended to illustrate the benefits of the present invention, but do not exemplify the full scope of the invention.

### EXAMPLE 1

### Halogen/Peroxygen

In this example, chlorine in the form of sodium hypochlorite was used in combination with potassium monopersulfate.

An amperometric sensor was utilized which incorporated an ion selective membrane to prevent dissolved solids from influencing the amperometric sensor. Therefore, only dissolved chlorine in the form of hypochlorous acid can permeate the membrane and influence the amperometric sensor. The sensor was calibrated for use with chlorine. The amperometric sensor and supporting hardware employed pH and temperature inputs for accurate determination of free chlorine. An ORP sensor was incorporated to measure water ORP values.

A circulating system with a 10-gallon reservoir was used for testing purposes (FIG. 1).

The circulating pump was turned on, the water was treated with sodium hypochlorite, and the pH was adjusted. Free chlorine concentration was verified using standard DPD methods with a HACH DR-2000 spectrophotometer. The amperometric controller was standardized then allowed to track while samples where periodically tested using DPD free chlorine test. The solution ORP was recorded periodically throughout the test period.

After ensuring the sensors had achieved equilibrium (stabilized readings), the solution was treated with various concentrations of potassium monopersulfate by addition into the top reservoir. After each addition of monopersulfate, the effect on both the amperometric reading and ORP reading were measured and recorded (Table 1).

TABLE 1

| | | | | | | Ampero- |
|---|---|---|---|---|---|---|
| | Approx. | | | HACH | Ampero- | metric |
| Persulfate | Time | | | Free | metric | Free |
| Addition | lapsed | ORP | | Chlorine | HOCl | Chlorine |
| (ppm) | (min) | mv | pH | (ppm) | (ppm) | (ppm) |
| 0 | 0 | 53 | 0.3 | 5.2 | 2.77 | 5.2 |
| 9 | 5 | 62 | 5.2 | n/a | 2.78 | 5.2 |
| 9 | 15 | 64 | n/a | n/a | 2.83 | 5.2 |
| 26 | 30 | 70 | n/a | n/a | 2.9 | 5.1 |
| 26 | 50 | 82 | 5.1 | 5.1 | 2.95 | 5.1 |

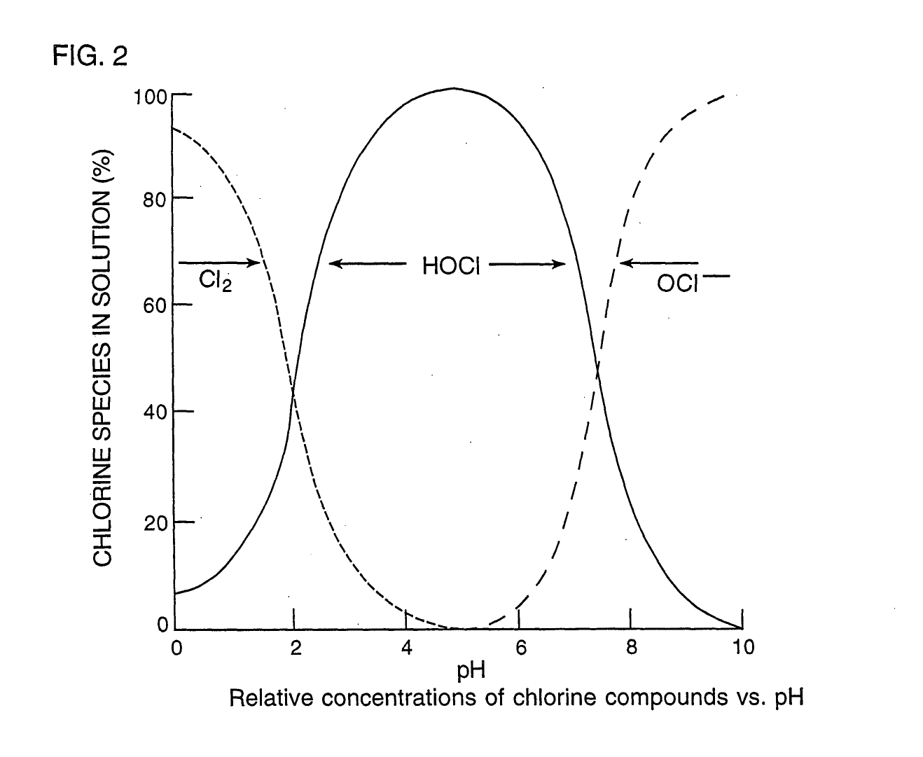

With the addition of the acid based monopersulfate, slight changes in pH induced a change in the measured hypochlorous acid (FIG. 2). However, the calculated free chlorine value remained stable since the monopersulfate exists as an ionized salt that cannot permeate the ion selective membrane.

It is evident from the results of this test that free chlorine concentration was accurately measured by the amperometric sensor while the ORP value was significantly influenced by the presence of the second oxidizer (potassium monopersulfate). Even with concentrations of monopersulfate magnitudes higher than that applied in actual application, free chlorine residual can be accurately measured by the specific species sensor, e.g. the amperometric sensor.

By incorporating this sensor technology into this dual oxidizer application, verification and optimization of chlorine feed can be achieved, even in the presence of other oxidizer species. Therefore, in aqueous systems where a halogen, such as chlorine, is used as the sanitizer, implementation of the control technology of the present invention would ensure that insufficient or low levels of a first oxidizing species, such as chlorine, would not occur due to the satisfied ORP value measured by an ORP-based controller.

Yet another benefit of this invention is the improved performance achieved through the optimized proportioning of the oxidizer. For instance, if sufficient chlorine is available to ensure sanitation and support its role in the oxidation processes, a second oxidizer could be selected and fed independent of the chlorine. Boolean logic or fuzzy logic can be effectively included to maximize performance through optimized proportioning of the oxidizers whether fed together or independently.

### EXAMPLE 2

### AOT Test 1

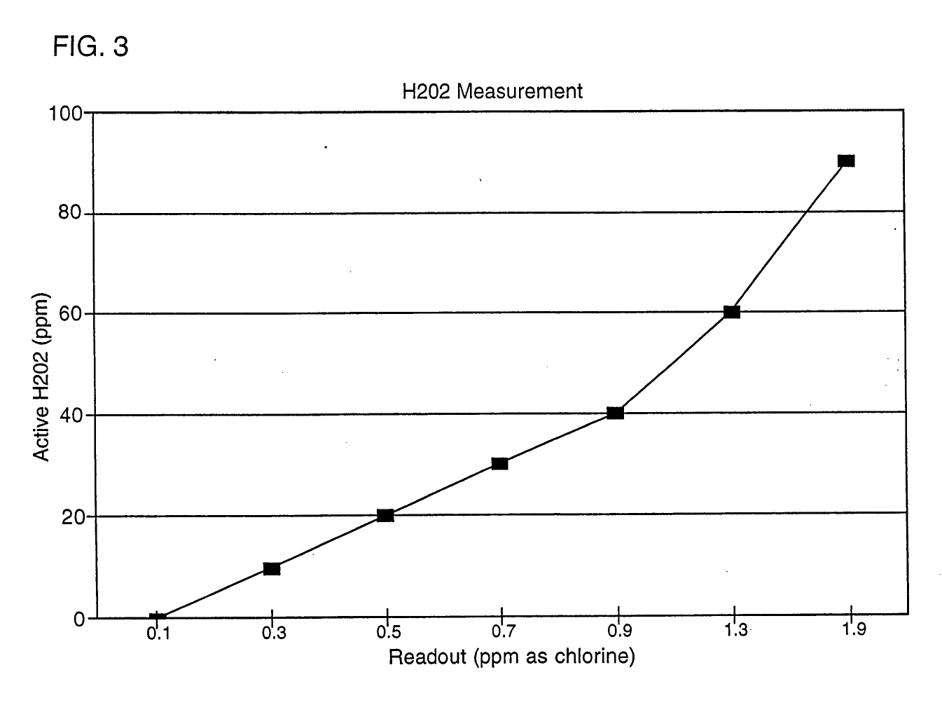

An amperometric sensor combined with a readout display was calibrated to report the measured value of hydrogen peroxide as chlorine. Hydrogen peroxide was incrementally added to the solution. The increase in the amperometric value is illustrated in FIG. 3. Based on these results, it is evident that amperometric technology can effectively detect the presence of hydrogen peroxide.

The same test was performed using an amperometric sensor incorporating an ion selective membrane. For the 90 ppm active concentration of hydrogen peroxide, the displayed value was 0.1 ppm as Cl₂. Thus, the utilization of a selective membrane can be used to provide an indication of an activity of a specific, target species. That is, based on these two tests, it is evident the employing these two types of amperometric methods of measure could allow for an accurate measure of oxidizers independently in a two oxidizer environment.

In typical AOT applications, hydrogen peroxide can be converted to form hydroxyl free radicals. This process can incorporate combining hydrogen peroxide with ozone, or contacting the hydrogen peroxide with UV radiation to initiate or produce the hydroxyl free radical species.

Hydroxyl free radicals typically rapidly react with many organic and inorganic contaminants found in many aqueous systems. However, if the concentration of hydroxyl radicals is to be optimized based on demand for the oxidizer, an accurate means of measuring this oxidizer in the presence of the second oxidizer must be employed.

ORP sensors typically do not provide an accurate method for measuring hydrogen peroxide. A specific sensor, such as an amperometric or a potentiometric sensor, or an analytical technique, can be applied as previously in accordance with the present invention. However, hydroxyl radicals can interfere with the amperometric sensor if present with the hydrogen peroxide. In order to adjust the concentration of hydroxyl radicals, an independent, specific measure of the hydroxyl radicals must be made while in the presence of residual hydrogen peroxide.

Like hypochlorous acid, hydroxyl radicals are typically nonionic. This enables them to permeate through ion selective membranes like that employed in the previous test. Hydrogen peroxide on the other hand possesses a strong anionic charge.

An amperometric or potentiometric sensor or an analytical system, calibrated to report the specific oxidizer concentration as, for example, chlorine or its equivalent, can be incorporated an ion selective membrane to provide a characterization of the specific oxidizer concentration in the aqueous system.

A sample of water was treated with 600 ppm of active hydrogen peroxide by adding 30% laboratory grade hydrogen peroxide to distilled water. A sample of solution was placed on a magnetic stirrer, the amperometric sensor with a selective membrane, was immersed into a sample of the solution, the stirrer was activated, and the sensor was allowed to equilibrate for approximately 30 minutes.

Another equal volume of sample was placed in a reaction vessel, in which a UV lamp was placed. The sample with the lamp was periodically immersed in a swirling ice bath to maintain temperature at 23° C. (±1° C.). The solution was exposed for approximately 30 minutes.

After equilibrating for approximately 30 minutes, the amperometric reading was recorded followed by the ORP, and temperature. After recording, the UV sample was given a final ice water bath to stabilize the solution temperature. The lamp was disengaged, and the amperometric sensor with the selective membrane was immersed into the solution. The magnetic stirrer was initiated and the sensor was allowed to equilibrate.

After approximately 60 seconds, the measured value on the display increased significantly and, in approximately three minutes, reached a value of about 8.38, as Cl₂, as illustrated in Table 2. The pH, ORP and temperature were also recorded.

TABLE 2

| | | Amperometric | | |
|---|---|---|---|---|
| Sample Name | Temperature ° C. | w/membrane | ORP | pH |
| Control | 23 | 0.37 | 245 | 7.25 |
| UV radiated | 23 | 8.38 | 240 | 7.25 |

### EXAMPLE 3

### AOT Test 2

To further demonstrate the ability to differentiate oxidizers and provide superior process control, a 500 ml sample of tap water was treated with 1 ml of about 30% hydrogen peroxide. 50 ml of solution was removed and radiated with UV for 30 minutes. The remaining 450 ml of peroxide solution was stirred using a magnetic stirrer, into which an amperometric sensor with a selective membrane was immersed.

After 30 minutes and temperature adjustment with an ice bath, the UV radiated solution was reintroduced to the starting 600 ppm solution. Because both solutions began with 600 ppm of active hydrogen peroxide, addition of the solution would not affect the concentration of peroxide and thereby induce interference to the reading. It is reasonable to assume it would reduce the peroxide concentration since some of the peroxide had been consumed in the production of hydroxyl radicals.

The measured results, listed in Table 3, clearly demonstrate the membrane-amperometric based technology has the ability to insulate the electrode from significant interferences induced by the presence of hydrogen peroxide, thereby allowing effective detection and measurement of hydroxyl radicals.

TABLE 3

| | Temperature | Amperometric |
|---|---|---|
| Sample Name | ° C. | w/membrane |
| Control | 22 | 1.1 |
| Treated | 22 | 8.3 |

Utilizing ion selective membrane-based amperometric technology with conventional amperometric technology can provide superior process control of two oxidizers in two oxidizer systems.

One example is to maintain sufficient hydrogen peroxide in a body of water, such as a pool, for sanitation with use of a standard amperometric sensor. Then enhancing oxidation of organics with hydroxyl radicals by applying selective membrane amperometric sensor-based technology to measure residual hydroxyl radicals directly, or by difference between the two gas membrane amperometric readings, one taken before and one after hydroxyl radicals are employed. This technique could effectively be applied to pools as well as other water treatment applications where oxidation using hydroxyl free radicals would effectively assist in the reduction of organic and other oxidizable inorganic substances.

To further illustrate other potential performance benefits offered by this process control system, with increased concern of cryptosporidium contamination of water, and the high chlorine tolerance of said organisms, the ability to control hydroxyl free radical concentrations offers the ability to destroy the protective lipid layer of the Cryptosporidium Oocyst by inoculating the water with effective doses of hydroxyl free radicals. Application of this technology with additional treatment and/or on-line monitoring could further improve water safety and quality.

The hydroxyl measurement can be used as part of a feedback control by which adjusting the introduction of hydroxyl radicals into the water to be treated, or by increasing the production rate of hydroxyl radicals by increasing or decreasing the ozone concentration or UV intensity and/or contact with the supporting oxidizer (peroxide or ozone) is controlled.

Yet another method of applying this technology to improve the effectiveness and efficiency of two-oxidizer systems when utilizing a halogen oxidizer is to measure the free halogen concentration with the ion selective membrane amperometric (or potentiometric) sensor (or analytical techniques), while also measuring the solution pH and ORP. An algorithm can be used to correlate the concentration of oxidizer demand, typically based on the required free halogen concentration, needed to achieve the measured ORP for a given measured pH. That is, for a given water quality, a specific concentration of free halogen oxidizer is typically required, at a given pH, to achieve a targeted ORP value. This concentration of halogen should not change unless the demand for the oxidizer changes (at a constant pH). If the measured free halogen concentration needed to achieve a targeted ORP increases, the demand in the water has increased. By using an algorithm to identify the presence of this demand, a second oxidizer can be employed to effectively address this demand. For example, the feed rate or production rate of hydroxyl radicals can be adjusted in real-time utilizing this form of control to maximize the performance of the treatment program.

Again, these control technologies can be further improved with the aid of Boolean or fuzzy logic.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings. For example, the term “water” has been used to refer to the treatment system of the present invention, it is to be understood that the present invention can be utilized to treat aquatic or aqueous systems or fluids including, but not limited to wastewater systems, swimming pools, spas and other similar systems. Further, for purposes of illustration, chlorine has been described as an oxidizer of the present invention. However, the use of chlorine is intended to be representative of a variety of oxidizers. For example, other oxidizers that sanitize by inactivating microorganisms or promoting decomposition of organic compounds be utilized as an oxidizer in accordance the systems and techniques of the present invention such as, but not limited to, free chlorine, free bromine or HOCl, OCl, HOBr, or OBr species. Moreover, a variety of techniques can be utilized to introduce one or more oxidizers in the present invention. For example, a free halogen species can be introduced by electrolytically generating free chlorine or by injecting chlorate compounds from a reservoir. A variety of communication techniques can also be utilized to effect communication between the controller and the various sensors of the present invention. For example, the sensors can be in wirelessly or wired communication with the controller.

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

What is claimed:

1. A system for treating water in an aqueous system comprising:
a species-specific sensor disposed to measure a halogen species concentration of water in the aqueous system;
an oxidation-reduction potential sensor disposed to measure an oxidation-reduction potential of the water; and
a controller in communication with the species-specific sensor and the oxidation-reduction potential sensor and with a halogen donor source and a peroxygen source, the controller comprising an algorithm that regulates addition of a halogen donor species based on the halogen species concentration and addition of a peroxygen compound based on the oxidation-reduction potential.

2. A system for treating water in an aqueous system comprising a controller in communication with a species-specific sensor disposed to measure a first oxidizer concentration of a first oxidizer in the aqueous system, a second sensor disposed to measure an overall oxidation reduction potential of the aqueous system, a first oxidizer source disposed to introduce the first oxidizer into the aqueous system, and a second oxidizer source disposed to introduce the second oxidizer into the aqueous system, the controller comprising an algorithm that analyzes the first oxidizer concentration and the second oxidizer concentrations and regulates addition of the first oxidizer based on the first oxidizer concentration and addition of the second oxidizer based on the second oxidizer concentration.

3. A method of treating water in an aqueous system comprising:
measuring a first oxidizer concentration of a specific oxidizer in water in the aqueous system;
determining a first oxidizer demand according a difference between the measured first oxidizer concentration and a target first oxidizer concentration;
controlling addition of the specific oxidizer to the aqueous system based on the first oxidizer demand; and
controlling addition of a second oxidizer to the aqueous system based on an oxidation reduction potential of water in the aqueous system.

4. The method of claim 3, wherein the step of controlling addition of the second oxidizer is further based on the first oxidizer demand.

5. The method of claim 3, wherein the specific oxidizer comprises a halogen donor.

6. The method of claim 5, wherein the second oxidizer comprises a peroxygen compound.
